(19) United States
(12) Patent Application Publication
(10) Pub. No.: US 2011/0194880 A1
(43) Pub. Date: Aug. 11, 2011

(54) TRANSFER ROLLER

(75) Inventors: Yoshinobu OGAWA, Ushiku-shi (JP); Mitsuru OKUDA, Moriya-shi (JP); Naoki KOYAMA, Ushiku-shi (JP)

(73) Assignee: CANON KASEI KABUSHIKI KAISHA, Ibaraki-ken (JP)

(21) Appl. No.: 13/012,276

(22) Filed: Jan. 24, 2011

(30) Foreign Application Priority Data
Feb. 5, 2010 (JP) 2010-023972

(51) Int. Cl. G03G 15/20

(52) U.S. Cl. 399/313

(57) ABSTRACT

A transfer roller is provide that less cause faulty image which is used in electrophotographic process such as copiers and laser-beam printers, in particular, used on the inner side of an intermediate transfer belt of a full-color image forming apparatus. It is a transfer roller which has a shaft and provided on the periphery thereof at least two conductive foamed rubber layers; the layers having an outermost layer which has a foamed rubber mean cell size of from 10 μm or more to less than 100 μm and an inner layer which has a foamed rubber mean cell size of from 100 μm or more to 500 μm or less; and, as measured in an environment of 23° C./55% RH, the roller having a resistance Rx of from 5.6 or more to 7.0 or less in Log Rx and the inner layer having a resistance Ry of from 5.0 or more to 7.0 or less in Log Ry.

### BACKGROUND OF THE INVENTION

1. Field of the Invention

This invention relates to a transfer roller used in image forming apparatus such as electrophotographic copying apparatus, printers and electrostatic recording apparatus. More particularly, it relates to a transfer roller of a transfer assembly by means of which transferable images composed of toner images having been formed and held on an image baring member such as an electrophotographic photosensitive member by an imaging means such as electrophotographic processing and electrostatic printing are transferred to a transfer material or a recording medium such as a paper sheet.

2. Description of the Related Art

Conventionally, in image forming apparatus of electrophotographic systems, such as copying apparatus and printers, the surface of an electrophotographic photosensitive member is first uniformly electrostatically charged, then a picture is projected onto this electrophotographic photosensitive member through an optical system and then the charge at the part exposed to light is erased to form a latent image. Subsequently, a toner is made to adhere to the latent image to form a toner image (development) and the toner image is transferred to a recording medium such as a transfer sheet or transfer material to perform printing. Such a method is employed.

As a means by which the toner image is transferred to the recording medium such as a transfer sheet or transfer material, a system is known in which the toner image is transferred thereto while a transfer roller to which a voltage is kept applied is brought into contact with the electrophotographic photosensitive member in the state the transfer sheet or transfer material is held between them and at a stated pressing force applied on the back side thereof. In recent years, in order to deal with color image formation, higher image quality and higher speed, it is required to keep a uniform nip width between the transfer roller and the electrophotographic photosensitive member, and it is desired for the transfer roller to have a surface with a low hardness and for its foam cells to be dense and uniform.

If the transfer roller has a surface profile that is uneven in conformity with foam cells, it may come into electrically non-uniform contact with the electrophotographic photosensitive member to cause a non-uniformity in transfer density which reflects such an electrical non-uniformity. Accordingly, the transfer roller is required to have a stated electrical resistance, and have a good surface smoothness and a high dimensional precision in order to secure uniform contact with the electrophotographic photosensitive member and so forth.

As a means which makes the transfer roller have a low hardness, a foam is used in many cases. Usually, the hardness of a foam depends on the size of cells which form the foam, where a foam with a low hardness has a large cell diameter and a foam with a high hardness has a small cell diameter. In the case of transfer rollers used in electrophotographic apparatus such as printers and copying machines, a foam with a low hardness, having a large cell diameter, is often used in order to secure the nip width surely. However, although the one having a large cell diameter can secure the nip width, it may often cause blank areas caused by poor transfer (i.e., transfer blank) of toner. A method is also employed in which, in order to improve transfer efficiency of the toner, a higher voltage is applied to the transfer roller so as to transfer the toner forcedly. However, if too high voltage is applied, the toner once having been transferred may be retransferred (come back) to the electrophotographic photosensitive member to make any good images not obtainable. Thus, it has been difficult to satisfy both the hardness and the transfer efficiency.

For example, as disclosed in Japanese Patent Application Laid-open No. 2006-259131, studies are made on a foamed roller which satisfies both the cell diameter and the hardness so as to make the transfer efficiency less vary. However, its hardness range is as broad as from 20 degrees to 50 degrees in Shore E hardness, where, if it is more than 30 degrees, any good nip that can deal with color image formation, higher image quality and higher speed is not obtainable in the foamed roller. Also, it has a resistance value of as high as about 8.0 in Log R, where a high voltage must be applied to the roller in order to improve the transfer efficiency, and this may cause the retransfer of toner. Still also, the relationship between the cell diameter and the transfer efficiency is taken up for a sufficient nip width, and any detailed studies are not made on the nip width.

As disclosed in Japanese Patent Application Laid-open No. 2004-322421, studies are made on a simple method for producing a foamed rubber roller made up of a single layer and having a small cell diameter on its outer side and a large cell diameter on its inner side. In this method, the cell diameter is controlled by the balancing of the viscosity of an unvulcanized rubber with the rate of vulcanization, where, if it is vulcanized by a batch process making use of a vulcanizing pan or a press, any non-uniformity in cell diameter and in thickness of that layer may come about between batches or between lots, so that any non-uniformity may come about in the resistance value of the foamed rubber roller. Studies are also made on a low-hardness roller, but any studies are not made on the relationship between foaming state and transfer performance, and nothing has been clarified about the relationship among hardness, foaming state and transfer performance.

Thus, in regard to transfer rollers, there are few publications reporting any studies on rollers that enable uniform transfer of toners, and there has been the problem that nothing has been clarified about the transfer performance that depends on the hardness and the state of contact.

### SUMMARY OF THE INVENTION

The present invention has been made taking account of the above problems. Accordingly, an object of the present invention is to provide a transfer roller that may less cause any faulty images such as toner retransfer and blank area caused by poor transfer (transfer blank), which is used in transfer assemblies of electrophotographic processers such as copying machines and laser beam printers, in particular, used on the inner side of an intermediate transfer belt of a full-color image forming apparatus.

That is, the present invention is a transfer roller which has a conductive shaft and provided on the periphery thereof at least two conductive foamed rubber layers; the foamed rubber layers having an outermost layer which has a foamed rubber mean cell size of from 10 μm or more to less than 100 μm and an inner layer which has a foamed rubber mean cell size of from 100 μm or more to 500 μm or less; and as measured in an environment of 23° C. and 55% RH, the roller having a resistance value Rx (Ω) of from 5.6 or more to 7.0 or less in Log Rx and the inner layer having a resistance value Ry (Q) of from 5.0 or more to 7.0 or less in Log Ry.

The transfer roller of the present invention can less cause any faulty images such as toner retransfer and blank area caused by poor transfer (transfer blank), and hence it is useful, in particular, as a transfer roller used on the inner side of an intermediate transfer belt of a full-color image forming apparatus.

Further features of the present invention will become apparent from the following description of exemplary embodiments with reference to the attached drawings.

### BRIEF DESCRIPTION OF THE DRAWINGS

FIG. 1 is a perspective view of a transfer roller according to the present invention.

FIG. 2 is a diagrammatic view to illustrate a full-color image forming apparatus.

### DESCRIPTION OF THE EMBODIMENTS

Preferred embodiments of the present invention will now be described in detail with reference to the accompanying drawings.

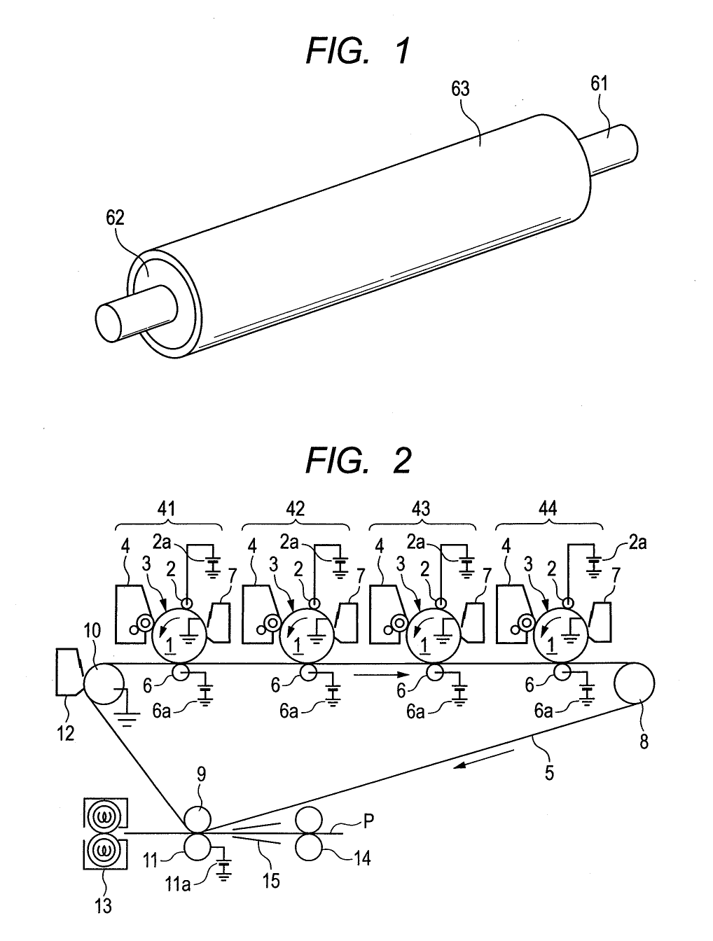

The transfer roller of the present invention is shown in FIG. 1 as a perspective view.

The transfer roller of the present invention has a conductive shaft 61 and provided on the periphery (external surface) thereof at least two conductive foamed rubber layers 62 and 63 (inner layer 62, outermost layer 63). Then, the outermost layer 63 of the foamed rubber layers has a foamed rubber mean cell size of from 10 μm or more to less than 100 μm and the inner layer 62 thereof has a foamed rubber mean cell size of from 100 μm or more to 500 μm or less. Herein, where the roller has three or more conductive foamed rubber layers, any layers other than the outermost layer 63 are termed as the inner layer as a whole. Then, the outermost layer is also termed as an outer layer. Also, in the following, the transfer roller may be considered to be a “conductive rubber roller” and may be taken as a base roller of any other roller(s) for electrophotography, to make evolution.

If the outermost layer has a foamed rubber mean cell size of less than 10 μm, the foamed rubber of the outermost layer may be too hard to secure any nip good enough to deal with the color image formation, higher image quality and higher speed. If the outermost layer has a foamed rubber mean cell size of not less than 100 μm, its surface may come so greatly uneven as to tend to cause the blank area caused by poor transfer (transfer blank) of toner. The outermost layer may preferably have a foamed rubber mean cell size of from 20 μm to 60 μm.

If the inner layer has a foamed rubber mean cell size of less than 100 μm, though different depending on the hardness and thickness of the outermost layer, the whole foamed rubber layer may come too hard to secure any good nip. If the inner layer has a foamed rubber mean cell size of more than 500 μm, cells may have open cells in so large a proportion as to result in poor resistance to compression set (C-SET). Also, where the foamed rubber layer surface is sanded in order to make the foamed rubber roller have the desired precision, the foamed rubber layers may be so soft as to have an inferior workability. Accordingly, the inner layer may preferably have a foamed rubber mean cell size of from 200 μm to 300 μm.

The transfer roller of the present invention has at least two conductive foamed rubber layers. This is because the foamed rubber mean cell size and resistance value of the outermost layer and inner layer of the foamed rubber layers can individually be controlled with ease by changing how raw materials for the foamed rubber layers are blended. Thus, forming the conductive foamed rubber layers in at least two layers facilitates control of the resistance value of the transfer roller. Also, even where any oil component such as a softening agent is added in order to make the inner layer have a low hardness, the inner layer is covered with the outermost layer and hence the oil component can not easily exude to the surface of the transfer roller and does not contaminate any member(s) coming into contact therewith.

The transfer roller of the present invention is required to have a resistance value Rx (Ω) of from 5.6 or more to 7.0 or less in Log Rx (Rx is the volume resistance) and the inner layer thereof a resistance value Ry (Ω) of from 5.0 or more to 7.0 or less in Log Ry (Ry is the surface resistance), as measured in an environment of 23° C. and 55% RH.

In order for the inner layer to otherwise have a Log Ry of less than 5.0, it is necessary for that layer to be incorporated with a conductive carbon black or a liquid ionic conductor. If it is incorporated with any conductive carbon black, it may come higher in its hardness and may come to be non-uniform in its electrical characteristics in the roller peripheral direction, to tend to cause transfer non-uniformity. Also, even if it is incorporated with any liquid ionic conductor, any transfer roller the inner layer of which has a Log Ry of less than 5.0 can not be produced in practice. Hence, the inner layer is made to have a Log Ry of 5.0 or more. If on the other hand it has a Log Ry of more than 7.0, a higher voltage must be applied to the transfer roller in order for the toner to be uniformly transferred, so that the toner can not be well prevented from being retransferred and hence poor images may come formed.

If it has a Log Rx of less than 5.6, it is necessary for the outermost layer to be incorporated with a conductive carbon black or a liquid ionic conductor. If it is incorporated with any conductive carbon black, it may come higher in its hardness and may come to be non-uniform in its electrical characteristics in the roller peripheral direction, to tend to cause transfer non-uniformity. Also, if it is incorporated with any liquid ionic conductor, there is a possibility that the conductor exudes to the roller surface to contaminate any member(s) coming into contact therewith. If on the other hand it has a Log Rx of more than 7.0, a higher voltage must be applied to the transfer roller in order for the toner to be uniformly transferred, so that the toner can not be well prevented from being retransferred and hence poor images may come formed. Also, since a higher voltage is to be kept applied, the conductive foamed rubber layers may fast come to deteriorate, resulting in an increase in resistance value of the transfer roller and a lowering of transfer efficiency.

In the present invention, the whole foamed rubber layer may suffice to have a thickness within which at least two layers can be formed, as long as the hardness necessary as the transfer roller can be secured. It is suitable for such at least two layers to have a thickness of usually from 1 mm to 10 mm in total. It is also suitable for the outermost layer to have a thickness of usually from 10% to 20% of the total thickness of the whole conductive foamed rubber layer. Further, the inner layer may usually be of a single layer, and may instead be of double or more layers taking account of the durability and the like of the whole conductive foamed rubber layer.

As the hardness of the transfer roller of the present invention, it is suitable for it to be from 10 degrees or more to 30 degrees or less in ASKER C hardness. In order for the transfer roller to otherwise have a hardness of less than 10 degrees, it must be produced in a higher foamed ratio, and hence it may have so large cell diameter and have open cells in so large a proportion as to result in poor resistance to compression set (C-SET), and also result in a small number of conduction sites, so that the transfer roller may have a high resistance value. In addition, its resistance value may change as a result of compression, and hence such a roller is unsuitable as the transfer roller. If on the other hand the transfer roller otherwise has a hardness of more than 30 degrees, it tends to provide an insufficient nip, resulting necessarily in a lowering of transfer efficiency. If a higher transfer voltage is applied in order to secure the transfer efficiency, the retransfer of toner tends to come about, where the conductive foamed rubber layers may fast come to deteriorate, resulting in an increase in resistance value of the transfer roller and a lowering of transfer efficiency. Hence, the transfer roller may preferably have a hardness of from 10 degrees or more to 30 degrees or less as ASKER C hardness, and much preferably from 15 degrees or more to 25 degrees or less.

The transfer roller of the present invention is produced by providing the conductive shaft with the foamed rubber layers on the former's periphery. A method for its production is described below.

As a rubber component of the foamed rubber layers, any material used commonly in conductive rubber rollers may be used without any difficulty. More specifically, any of general-purpose rubbers such as butadiene rubber, isoprene rubber, chloroprene rubber and styrene-butadiene rubber, ethylene-propylene-diene rubber, epichlorohydrin type rubbers, acrylonitrile butadiene rubber and so forth may be used alone or in the form of a mixture. In particular, epichlorohydrin type rubbers and acrylonitrile butadiene rubber are preferred as having ionic conductivity in themselves.

The epichlorohydrin type rubbers may include a homopolymer of epichlorohydrin (EC), a copolymer with ethylene oxide (EO) and also a terpolymer with allyl-glycidyl ether (AG). Further, in the present invention, the epichlorohydrin type rubbers shall include an EO/propylene oxide (PO)/AG terpolymer. Of these epichlorohydrin type rubbers, an EC/EO/AG terpolymer, an EC/PO/AG terpolymer and a mixture of these are preferred. The epichlorohydrin type rubbers become lower in electrical resistance with an increase in EO content, and also tend to be crystallized at their EO chain moieties if the EO content is too large, tending to come high in both resistance and environmental dependence. Accordingly, those having an EO content of from 40 mole % to 80 mole % are preferred.

To the above rubber component, a vulcanizing agent, a vulcanizing accelerator and a blowing agent, and also optionally a conducting agent may be added to prepare a raw-material rubber composition for conductive foamed rubber layers each.

As the vulcanizing agent, usable are, e.g., sulfur, sulfur-containing organic compounds, organic peroxides, triazines and polyamines, which may differ depending on raw-material rubbers to be used. Also, as the vulcanizing accelerator, it may include thiuram type, thiazole type, guanidine type, sulfenamide type, dithiocarbamate type and thiourea type vulcanizing accelerators. Further, as the blowing agent, it may include p,p′-oxybissulfonyl hydrazide (OBSH), azodi-carbonamide (ADCA) and dinitrosopentamethylenetetramine (DPT), and a blowing aid such as a urea type compound may also be used for the above.

As the conducting agent which may optionally be added, it may include carbon powders such as carbon black, graphitized carbon black and carbon nanotube; metal powders; conductive metal oxides of various types such as titanium oxide; and ionic conductors such as LiClO₄ and NaSCN. Any of these may also be used alone or in combination of some types.

In the present invention, any other various components to be blended into rubbers may optionally be blended, as exemplified by processing aids such as a lubricant and a factice; antioxidants; vulcanizing accelerator aid such as zinc oxide and stearic acid; and fillers such as calcium carbonate, talc, silica and clay.

The transfer roller of the present invention may be produced in the following way, for example. An unvulcanized conductive rubber composition is obtained by kneading the materials by means of a closed mixing machine such as Banbury mixer or a kneader or an open roll, and then the rubber composition obtained is extruded by means of an extruder able to carry out double-layer simultaneous extrusion, to obtain an unvulcanized double-layer tube. The outer layer of the unvulcanized double-layer tube obtained as a result of extrusion may preferably be 1 mm or more, and more preferably 2 mm or more, in thickness. This unvulcanized double-layer tube is heated and foamed by using a vulcanizing pan or using UHF waves and a continuous vulcanizing oven, to make a tube of a conductive foamed rubber (an elastic body), and thereafter secondary vulcanization is optionally carried out. The secondary vulcanization is effective in making cross-link density higher and keeping any bleeding from occurring, and hence it is preferable to carry out such secondary vulcanization. The conductive foamed rubber tube thus obtained is cut into a tube with a stated length, and thereafter the conductive shaft 61 is inserted into it, followed by sanding until the tube comes to have the desired outer diameter, thus the transfer roller is obtained which has the conductive foamed rubber layers 62 and 63.

An example of an image forming apparatus making use of the transfer roller of the present invention is shown in FIG. 2 as a diagrammatic view. This image forming apparatus is an apparatus provided with electrophotographic photosensitive members 1 (photosensitive members 1) in the number corresponding to developers necessary for image formation, and is usable in full-color printing, i.e., a full-color image forming apparatus.

This image forming apparatus has four image forming sections 41 to 44, which are each set up alike. More specifically, the image forming sections 41 to 44 are each consist basically of an electrophotographic photosensitive member 1, a charging roller 2, an image information writing beam 3, a developing assembly 4 and a primary transfer roller 6 by means of which each-color toner image formed on the photosensitive member 1 is transferred to an intermediate transfer belt 5. A cleaning member 7 is further provided in contact with each photosensitive member 1 in order to remove any toner remaining on the photosensitive member 1 after the toner image has been transferred to the intermediate transfer belt 5. Then, a neutralization member (not shown) may also optionally be provided in order to eliminate any electric charges remaining on the photosensitive member 1. In this drawing, constituents common to the respective image forming sections are denoted by the like reference numerals for the purpose of simplicity. Also, this image forming apparatus is one making use of, as toners, yellow (Y), magenta (M), cyan (C) and black (K) toners. In order to provide more delicate and finer color make-up, any other image forming section(s) may be added so as to enrich color make-up. Further, in this example, the photosensitive member 1, the charging roller 2, the developing assembly 4 and the cleaning member 7 may integrally be joined to set up a process cartridge. Any of these may appropriately differently be joined to set up the process cartridge.

This image forming apparatus is one making use of an intermediate transfer belt 5, and the intermediate transfer belt 5 is set up as an endless belt held between each electrophotographic photosensitive member 1 and the primary transfer roller 6, and is further put over a drive roller 8, a tension roller 9 and a follow-up roller 10.

A secondary transfer roller 11 by means of which a full-color toner image held on the intermediate transfer belt 5, composed of toner images of respective colors which have been transferred thereto, is transferred to a transfer material P coming inserted in synchronization with the intermediate transfer belt 5 is so provided as to come face to face with the tension roller 9 and interpose the intermediate transfer belt 5 between them to form a secondary transfer zone. Further, in order to remove any toners remaining on the intermediate transfer belt 5, an intermediate transfer belt cleaning assembly 12 is so provided in contact with the intermediate transfer belt 5 as to come face to face with the follow-up roller 10.

Meanwhile, in order to fix to the transfer material P the full-color toner image having been transferred to the transfer material P, a fixing assembly consisting basically of a pair of rollers having a heating unit in the interior is provided at the lower part to which the transfer material P is to be transported. In FIG. 2, reference numeral 14 denotes a pair of feed rollers which feeds the transfer material P to the secondary transfer zone; and 15 donates a guide provided in order to feed the transfer material P to the secondary transfer zone.

Further, each charging roller 2, each primary transfer roller 6 and the secondary transfer roller 11 are each provided with a power source for controlling electric charges. In FIG. 2, each reference numeral 2a denotes a power source for the charging roller; each 6a, a power source for the primary transfer roller; and 11a, a power source for the secondary transfer roller. In this example, each charging roller 2, each primary transfer roller 6 and the secondary transfer roller 11 which are shown therein are each of a conductive roller type, which instead may be of any other discharge type as long as the primary transfer roller 6 at least is the transfer roller of the present invention.

In this example, each developing assembly 4 has a developing roller (also termed “developing sleeve”) set face to face with each photosensitive member 1, and, in contact with this developing roller, a toner feed roller is provided which scrapes off any toner having returned without being used on the photosensitive member 1 and feeds a fresh toner to the developing roller. A developer blade is also provided in order for the toner to be uniformly electrostatically charged and for the toner to be held on the developing roller in an even level. Here, as each toner, a non-magnetic one-component developer is used. The developing roller, the developer blade and so forth differ in their set-up depending on the color of each toner, and also the voltage to be applied to each developing roller in order to make the toner fly from the developing roller to the photosensitive member to perform development is set optimal. Further, each developing assembly 4 is provided therein with an agitating blade (not shown) in order that the toner having returned from the photosensitive member may uniformly be mixed with the fresh toner and the charge of the toner in the assembly can uniformly be retained.

Image formation performed by this full-color image forming apparatus is described below.

First, each photosensitive member 1 standing rotated in the direction of the photosensitive member 1 at a stated speed is electrostatically charged by the charging roller 2. For this charging, only a direct-current voltage may be applied, or an alternating-current voltage may further be applied in the state it is superimposed on the direct-current voltage. The photosensitive member 1 thus charged is rotated and, at its position to be exposed to the image information writing beam 3, exposed to image information writing beams kept provided with image information having been formed in accordance with each color, so that an electrostatic latent image corresponding to the image information is formed on the surface of the photosensitive member 1. Next, as the photosensitive member 1 is rotated, this electrostatic latent image comes to the position of the developing assembly 4, and is, at that position, supplied with the toner of each color from the developing assembly 4 to come into a toner image (visible image) on the surface of the photosensitive member 1.

The toner image having been formed on the surface of each photosensitive member 1 comes to the position between the photosensitive member 1 and the primary transfer roller 6, when it is transferred from the surface of the photosensitive member 1 to the surface of the intermediate transfer belt 5. Meanwhile, the photosensitive member 1 from which the toner image has been transferred is further rotated and is neutralized as necessary. Thereafter, any toners and dust remaining on its surface is removed by the cleaning member 7, and the photosensitive member 1 thus cleaned is used for the next image formation.

The respective image forming sections are operated in conformity with the process speed, and toner images corresponding to the respective image forming sections are formed. Subsequently, the toner images formed at the respective image forming sections are sequentially transferred onto the intermediate transfer belt 5 and the toner images of respective colors are superimposed thereon to form the full-color toner image. Thereafter, the intermediate transfer belt 5 carrying thereon such toner images is moved in the direction of an arrow, and then the toner images are one time transferred therefrom by the aid of the secondary transfer roller 11, to a transfer material P having been fed in the manner synchronized with the movement of the intermediate transfer belt 5. Any toners and dust remaining on the intermediate transfer belt 5 are then removed with the intermediate transfer belt cleaning assembly 12. The intermediate transfer belt 5 is further moved back to the image forming sections, and is used for superimposing thereon the next toner images of respective colors.

The transfer material P carrying thereon the full-color toner image composed of the toner images of respective colors that have one time transferred thereto is separated from the intermediate transfer belt 5, and then sent to the fixing assembly 13, where the full-color toner image is heated and fixed to the transfer material P as a full-color image. Thereafter, this transfer material P with the full-color image is taken out of the main body of the full-color image forming apparatus as an image-formed matter (a copy).

### EXAMPLES

The present invention is described below in greater detail by giving Examples and Comparative Examples. The present invention is by no means limited to these Examples.

Rubber materials used in each Example and Comparative Example are as follows:

### 1. Rubber Components:

Acrylonitrile-butadiene rubber (NBR) (bound acrylonitrile content: 18% by mass; trade name: NIPOL DN401LL; available from Nippon Zeon Co., Ltd.)

Epichlorohydrin rubber (ECR)
ECR 1 (ethylene oxide content: 73 mole %; trade name: EPION 301; available from Daiso Co., Ltd.)
ECR 2 (ethylene oxide content: 64 mole %; trade name: HYDRIN T3108; available from Nippon Zeon Co., Ltd.)

Polyether type copolymer (PEPA) (ethylene oxide-propylene oxide-allyl glycidyl ether copolymerization ratio: 87:1:12; trade name: ZEOSPAN 8010; available from Nippon Zeon Co., Ltd.)

### 2. Vulcanizing Agent:

Sulfur [sulfur (S) (trade name: SULFAX PMC; available from Tsurumi Kagaku Kogyo K.K.)]

### 3. Vulcanizing Accelerators:

M [2-mercaptobenzothiazole (M) (trade name: NOCCELER M; available from Ouchi-Shinko Chemical Industrial Co., Ltd.)]

DM [dibenzothiazyl disulfide (DM) (trade name: NOCCELER DM; available from Ouchi-Shinko Chemical Industrial Co., Ltd.)]

TET [tetraethylthiuram disulfide (TET) (trade name: NOCCELER TET, available from Ouchi-Shinko Chemical Industrial Co., Ltd.)]

### 4. Vulcanizing Accelerator Aids:

Zinc oxide (zinc oxide; trade name: Zinc White, two types; available from HakusuiTech Co., Ltd.)
Stearic acid (stearic acid; trade name: Stearic Acid TUBAKI; available from NOF Corporation)

### 5. Fillers:

Ca crb. (calcium carbonate; trade name: NANOX #30; available from Maruo Calcium Co., Ltd.)

CB (carbon black; trade name: ASAHI #15; available from Asahi Carbon Co., Ltd.)

### 6. Blowing Agents:

OBSH [p,p′-oxybis-sulfonyl hydrazide (OBSH) (trade name: NEOCELBON #1000S; available from Eiwa Chemical Ind. Co., Ltd.)]

ADCA [azodicarbonamide (ADCA); (trade name: VINYFOR AC #LQ; available from Eiwa Chemical Ind. Co., Ltd.)]

### 7. Blowing Aid:

Urea (trade name: CELLPASTE 101; available from Eiwa Chemical Ind. Co., Ltd.)

### 8. Softening Agent:

Sebacic acid type polyester (trade name: POLYCIZER P-202; available from DIC Corporation)

### 9. Ionic Conductor:

Quaternary ammonium salt (trade name: ADEKACIZER LV70; available from Adeka Corporation)

### 10. Conductive Carbon Black:

Carbon black (trade name: ASAHI #70; available from Asahi Carbon Co., Ltd.)

Blends 1 to 12 (Rubber raw-materials for foamed rubber layers)

The above raw materials were kneaded by means of Banbury mixer and an open roll under raw-material formulation shown in Table 1 below, to prepare Blends 1 to 12 for foamed rubber layers.

TABLE 1

| | | Raw-material formulation (part(s) by mass) | | | | | | | | | | | |
|---|---|---|---|---|---|---|---|---|---|---|---|---|---|
| Blend No. | | 1 | 2 | 3 | 4 | 5 | 6 | 7 | 8 | 9 | 10 | 11 | 12 |
| Rubber | NBR | 25.0 | 35.0 | 25.0 | 25.0 | 15.0 | 40.0 | 25.0 | 10.0 | 25.0 | 25.0 | 10.0 | 35.0 |
| components | ECR 1 | 65.0 | 55.0 | 65.0 | — | — | 50.0 | 65.0 | — | — | — | — | 55.0 |
| | ECR 2 | — | — | — | 65.0 | 75.0 | — | — | 80.0 | 65.0 | 65.0 | 80.0 | — |
| | PEPA | 10.0 | 10.0 | 10.0 | 10.0 | 10.0 | 10.0 | 10.0 | 10.0 | 10.0 | 10.0 | 10.0 | 10.0 |
| Vulcanizing agent, | | 1.0 | 1.0 | 1.0 | 1.0 | 1.0 | 1.0 | 1.0 | 1.0 | 1.0 | 1.0 | 1.0 | 1.0 |
| sulfur (S) | | | | | | | | | | | | | |
| Vulcanizing | M | — | — | 0.5 | 0.5 | 1.0 | — | 0.5 | 1.0 | 0.5 | 0.5 | 1.0 | — |
| accelerators | DM | 1.5 | 1.5 | 1.5 | 1.5 | 1.5 | 1.5 | 1.5 | 1.5 | 1.5 | 1.5 | 1.5 | 1.5 |
| | TET | 1.5 | 1.5 | 1.5 | 1.5 | 1.5 | 1.0 | 1.5 | 2.5 | 1.5 | 1.5 | 1.5 | 1.5 |
| Vulcanizing | Zinc | 5.0 | 5.0 | 5.0 | 5.0 | 5.0 | 5.0 | 5.0 | 5.0 | 5.0 | 5.0 | 5.0 | 5.0 |
| accelerator | oxide | | | | | | | | | | | | |
| aids | Stearic | 1.0 | 1.0 | 1.0 | 1.0 | 1.0 | 1.0 | 1.0 | 1.0 | 1.0 | 1.0 | 1.0 | 1.0 |
| | acid | | | | | | | | | | | | |
| Fillers | Ca crb. | — | 5.0 | — | — | — | 5.0 | — | — | — | — | — | 5.0 |
| | CB | 30.0 | 30.0 | 20.0 | 10.0 | 10.0 | 40.0 | 10.0 | 5.0 | 10.0 | — | 10.0 | 35.0 |
| Blowing | OBSH | 6.0 | 6.0 | 4.0 | — | — | 6.0 | 4.0 | — | — | — | — | 6.0 |
| agents | ADCA | — | — | — | 4.0 | 4.0 | — | — | 4.0 | 4.0 | 4.0 | 4.0 | — |

| | | | | | | | | | | | | |
|---|---|---|---|---|---|---|---|---|---|---|---|---|
| Blowing aid (urea) | — | — | — | 2.0 | 2.0 | — | — | 2.0 | 2.0 | 2.0 | 2.0 | — |
| Softening agent | — | — | — | 5.0 | 5.0 | — | — | 5.0 | 5.0 | 5.0 | 7.0 | — |
| Ionic conductor | — | — | — | — | — | — | — | — | 2.0 | — | — | — |
| Conductive carbon | — | — | — | — | — | — | — | — | — | 40.0 | — | — |
| black | | | | | | | | | | | | |

### Examples 1 to 7 and Comparative Examples 1 to 6

The above blends, used in combination as shown in Table 2, were extruded by means of an extruder able to carry out double-layer simultaneous extrusion, to form unvulcanized double-layer tubes. Here, this double-layer simultaneous extruder is one having an extruder of 60 mm in screw diameter and an extruder of 70 mm in screw diameter which are connected through a cross head, and is one which is necessary for the outer layer to be adjusted for its centering, but makes use of a double-heart shaped mandrel and hence enables extrusion of a tube of double-layer structure with less eccentricity. The unvulcanized double-layer tubes obtained were each so made as to have an inner layer and an outer layer the inner layer of which came to be 3.5 mm in thickness as a result of foaming and the outer layer of which came to be 1 mm to 2 mm in thickness that was able to secure its thickness of 0.5 mm as a result of sanding. The unvulcanized double-layer tubes obtained were each vulcanized and foamed by means of a vulcanizing pan to make conductive foamed rubber tubes. The conductive foamed rubber tubes were each cut into a tube of 240 mm in length, and then a conductive shaft of 6 mm in diameter, made of stainless steel, having been provided with chemical nickel plating and coated with an adhesive was inserted into each tube, thus roller-shaped forms were obtained. The forms obtained were so sanded as to come to be 14 mm in outer diameter each, and their part of each foamed rubber tube was so cut off at both end portions thereof as to be 226 mm in length, thus transfer rollers of Examples 1 to 7 and Comparative Examples 1 to 6 were produced.

Here, the resistance value of each transfer roller and the resistance value of its inner layer were controlled by the blending ratio of the rubber components, and the hardness of foamed rubber layers were controlled by changing the rate of vulcanization, the amount of the blowing agent, vulcanization conditions and so forth. The measurement of cell diameter, resistance value and hardness and the evaluation of C-SET and image were made according to the following. Results obtained are shown in Table 2.

Measurement of Cell Diameter

Each conductive foamed rubber tube produced was cut at three points in the lengthwise direction and in a width of 5 mm, and cross sections of cut tubes each were observed on an electron microscope, where the diameters of foam cells present within the range of 9 mm² were measured, and their average value was found on each of the inner layer and the outer layer.

Resistance Value of Transfer Roller

Each transfer roller produced was so set that a load of 4.9 N for each side was applied to both ends of its shaft, and then brought into pressure contact with a drum made of aluminum which was 30 mm in outer diameter, where the drum made of aluminum was rotated and was so controlled that the transfer roller was rotated at 30 rpm. Subsequently, in the state that its rotation became stable, a voltage of 50 V was applied between the shaft and the drum made of aluminum, and the value of voltage applied to an internal resistance of 1 kΩ connected in series was measured in an environment of 23° C./55% RH (N/N: normal temperature/normal humidity). From the voltage value found, the resistance value of the transfer roller was calculated by the Ohm's law.

Resistance Value of Inner Layer of Foamed Rubber Layers

Each transfer roller produced was sanded only for the thickness of the outermost layer to remove the outermost layer to produce a transfer roller having the inner layer only, where the resistance value of the inner layer was found in the same way as the resistance value of the transfer roller.

Measurement of Hardness of Transfer Roller

Against each transfer roller produced, an ASKER C hardness meter was slowly pressed at a load of 4.9 N, and the numerical value after 5 minutes was measured. This was measured by the method according to JIS K 6253.

Evaluation of Compression Set (C-SET)

Each transfer roller produced was brought into contact with a photosensitive member of a cartridge of a color laser beam printer (COLOR LASERJET 4700dn (trade name), manufactured by Hewlett-Packard Co.) under application of a load of 4.9 N at both ends of the shaft, and this was left to stand for a week in an environment of 40° C./95% RH (H/H: high temperature/high humidity). Thereafter, the load was removed and, after leaving for 10 minutes, any pressure contact marks on the roller surface was observed to make evaluation according to the following criteria.

A: Any pressure contact mark is not seen.
C: Pressure contact mark is seen.

Evaluation of Image

Each transfer roller produced was set as a transfer roller in an intermediate transfer belt (ITB) unit of the color laser beam printer (COLOR LASERJET 4700dn (trade name), manufactured by Hewlett-Packard Co.), and monochromatic solid images were printed in an environment of 15.0° C./10% RH (L/L: low temperature/low humidity). The monochromatic solid images obtained were visually observed to examine the level of color non-uniformity and color blank (transfer blank) to make evaluation according to the following criteria.

A: Both color non-uniformity and color blank involve no problem in practical use.
B: Any of color non-uniformity and color blank is/are seen, but no problem in practical use.
C: Color non-uniformity and color blank are seen, and not tolerable in practical use.

TABLE 2

| | | Cell diameter | | Resistance * | | Roller | | |
|---|---|---|---|---|---|---|---|---|
| Blends | | (μm) | | values | | hardness | | |
| Outer | Inner | Outer | Inner | Inner | | ASKER C | Evaluation | |
| layer | layer | layer | layer | layer | Roller | (deg.) | C-SET | Image |

Example:

| | | | | | | | | | |
|---|---|---|---|---|---|---|---|---|---|
| 1 | 1 | 4 | 30 | 300 | 5.8 | 5.7 | 23 | A | A |
| 2 | 2 | 5 | 15 | 450 | 6.3 | 5.9 | 21 | A | A |
| 3 | 3 | 5 | 90 | 450 | 6.3 | 6.2 | 17 | A | A |
| 4 | 2 | 7 | 15 | 110 | 5.7 | 5.6 | 30 | A | A |
| 5 | 1 | 9 | 30 | 280 | 5.0 | 5.6 | 23 | A | A |
| 6 | 3 | 11 | 90 | 500 | 6.4 | 6.2 | 9 | A | B |
| 7 | 12 | 7 | 10 | 110 | 5.7 | 5.6 | 33 | A | B |

Comparative Example:

| | | | | | | | | | |
|---|---|---|---|---|---|---|---|---|---|
| 1 | 6 | 5 | 8 | 450 | 6.3 | 5.9 | 22 | A | C |
| 2 | 7 | 5 | 110 | 450 | 6.3 | 6.3 | 15 | A | C |
| 3 | 8 | 3 | 15 | 90 | 5.6 | 5.6 | 35 | A | C |
| 4 | 2 | 8 | 15 | 550 | 6.6 | 6.4 | 16 | C | C |
| 5 | 1 | 10 | 30 | 90 | 4.4 | 5.6 | 39 | A | C |
| 6 | 10 | 4 | 90 | 300 | 5.8 | 4.5 | 38 | A | C |

* Resistance values are LogRx for the roller and LogRy for the inner layer.

It is seen from Table 2 that the transfer rollers which are those within the scope of the present invention (Examples 1 to 7) have no problem on the compression set (C-SET) and can contribute to good images.

On the other hand, in Comparative Example 1, the outer layer has a cell diameter of not more than 10 μm, which does not provide any good nip, and hence faulty images have occurred. In Comparative Example 2, the outer layer has a cell diameter of not less than 100 μm, where the blank area caused by poor transfer (transfer blank) of toner have occurred. In Comparative Example 3, the inner layer has a cell diameter of less than 100 μm, where the foamed rubber layer is too hard to provide any good nip, and hence faulty images have occurred. In Comparative Example 4, the inner layer has a cell diameter of more than 500 μm, and hence has resulted in poor resistance to compression set (C-SET). In Comparative Example 5, the inner layer contains carbon black to have a Log Ry of less than 5.0 and also the inner layer has a cell diameter of less than 100 μm, where the foamed rubber roller is too hard to provide any good nip, and hence faulty images have occurred. In Comparative Example 6, the outer layer contains carbon black, where the foamed rubber roller is too hard to provide any good nip, and hence faulty images have occurred.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-023972, filed Feb. 5, 2010, which is hereby incorporated by reference herein in its entirety.

What is claimed is:

1. A transfer roller which comprises a conductive shaft and provided on the periphery thereof at least two conductive foamed rubber layers;
the foamed rubber layers having an outermost layer which has a foamed rubber mean cell size of from 10 μm or more to less than 100 μm and an inner layer which has a foamed rubber mean cell size of from 100 μm or more to 500 μm or less; and
as measured in an environment of 23° C. and 55% RH, the roller having a resistance value Rx (Ω) of from 5.6 or more to 7.0 or less in Log Rx and the inner layer having a resistance value Ry (Ω) of from 5.0 or more to 7.0 or less in Log Ry.

2. The transfer roller according to claim 1, which has a hardness of from 10 degrees or more to 30 degrees or less as ASKER C hardness.
